(19) United States
(12) Patent Application Publication
(10) Pub. No.: US 2019/0176664 A1
(43) Pub. Date: Jun. 13, 2019

(54) PROTECTIVE COVER FOR A MOTOR VEHICLE SEAT

(71) Applicant: Hans-Karl Walser, Hohenems (AT)

(72) Inventor: Hans-Karl Walser, Hohenems (AT)

(21) Appl. No.: 16/191,900

(22) Filed: Nov. 15, 2018

(30) Foreign Application Priority Data
Dec. 12, 2017 (AT) A 475/2017

(51) Int. Cl. B60N 2/58; B60N 2/80

(52) U.S. Cl. CPC B60N 2/58; B60N 2002/899; B60N 2/80

(57) ABSTRACT

A protective cover for a motor vehicle seat, wherein the protective cover is formed of a cover fabric (3) which is provided with at least one slot (4). The slot (4) is underlaid by a strip (5) which is connected on either side of the slot (4) to the cover fabric (3). The strip (5) is configured to be elastically expandable at least in a central region, with the slot (4) being located above this region, and is provided with at least two, preferably at least five, incisions or openings (8) which are spaced apart from one another in the longitudinal direction of the strip (5) and which are accessible through the slot (4).

### INCORPORATION BY REFERENCE

The following documents are incorporated herein by reference as if fully set forth: Austrian Patent Application No. A475/2017, filed Dec. 12, 2017.

### BACKGROUND

The invention relates to a protective cover for a motor vehicle seat, wherein the protective cover comprises a cover fabric which is provided with at least one slot, which is underlaid by a strip which is connected on either side of the slot to the cover fabric.

In order to reduce costs for production and storage, it is desirable to configure protective covers such that they are able to be used for different types of motor vehicle seat. A difference in the various types of motor vehicle seat, for example, is that anchoring rods for headrests are connected at different points to receivers on the upper narrow face of the backrest. To this end, the protective cover disclosed in AT 406 036 B of the type mentioned in the introduction provides a slot, which is underlaid by a strip, in the region of the cover fabric which extends over the upper narrow face of the backrest. The user cuts holes into this strip at the desired points for passing through the anchoring rods. The effort associated therewith and/or the risk of introducing the holes at incorrect points, however, is regarded as a drawback by many users.

It is disclosed in WO 2013/026074 A1 to provide a zip fastener with a plurality of sliders. The zip fastener extends over the upper narrow face of the backrest and openings for the anchoring rods may be configured between two respective sliders. Thus, it may also be possible to pass through other functional elements which are provided on the seat, for example an opening may be configured on a lateral narrow face of the backrest for passing through a control element of the seat. A drawback here is that anywhere a potential through-passage for a functional element is to be made possible, a zip fastener has to be provided. Such zip fasteners increase the cost of the protective cover and the appearance of a protective cover with such zip fasteners in some cases is perceived by users as unattractive.

### SUMMARY

It is the object of the invention to provide an advantageous protective cover of the type mentioned in the introduction which in a simple manner permits the through-passage of functional elements of the vehicle seat, for example anchoring rods for a headrest. This is achieved by a protective cover having one or more features of the invention.

In the protective cover according to the invention, the strip by which the slot is underlaid is configured to be elastically expandable at least in a central region, said slot being located above said region. The strip is also provided with at least two, preferably at least five, incisions or openings which are spaced apart from one another in the longitudinal direction of the strip. These incisions or openings are accessible through the slot.

It is thus possible to pass functional elements of the motor vehicle seat, for example anchoring rods for a headrest, through the slot in the cover fabric and through the incisions or openings in the strip. In this case, the slot in the cover fabric may be arranged such that it extends over a region in which different types of vehicle seat have the relevant functional element at different positions. Depending on the actual position of the functional element according to the application, this functional element may be passed through one of the incisions or openings in the strip, wherein due to the elasticity of the strip the incision and/or opening in the strip is adaptable, if required, to the exact position of the functional element which is respectively present.

In order to enable the functional element to be passed through one of the incisions and/or one of the openings of the strip, for any positions of the functional element located in the region of the slot, the spacings between successive incisions or openings are preferably less than 2 cm, particularly preferably less than 1 cm, measured in the longitudinal direction of the strip.

In order to permit a sufficiently large displacement of the incisions and/or openings in the strip due to the elasticity of the strip, the spacing between the connecting regions of the strip with the cover fabric, said connecting regions being located on either side of the slot, is preferably at least 8 mm, particularly preferably at least 1 cm, measured at right-angles to the longitudinal extent of the slot.

Advantageously, it is provided that the strip as a whole or at least in the region in which it is configured to be elastic, comprises a rubber-elastic material or consists of such a material. The rubber-elastic material may in this case form a continuous layer, i.e. it may be configured in the manner of a film.

In a further possible embodiment, the strip is configured from individual threads, i.e. it is formed of a textile material. The strip in this case may be configured as knitted fabric, in particular machine-knit or—with a sufficient elasticity of the threads—woven.

Preferably, the strip in the region of the incisions or openings is sufficiently elastically expandable that by elastic deformation of the strip one respective incision and/or one respective opening is displaceable sufficiently far in the longitudinal direction of the strip that this incision and/or this opening enters a region in which an adjacent incision and/or an adjacent opening is present when the strip is unexpanded.

### BRIEF DESCRIPTION OF THE DRAWINGS

Further advantages and details of the invention are described hereinafter with reference to the accompanying drawing, in which:

FIG. 1 shows a perspective view of a motor vehicle with a protective cover according to an exemplary embodiment of the invention;

FIG. 2 shows a plan view of the upper face of the seat back with the protective cover without the headrest; and

FIG. 3 shows a schematic perspective view of a portion of the protective cover in the region of the upper face of the backrest, in cross section.

### DETAILED DESCRIPTION

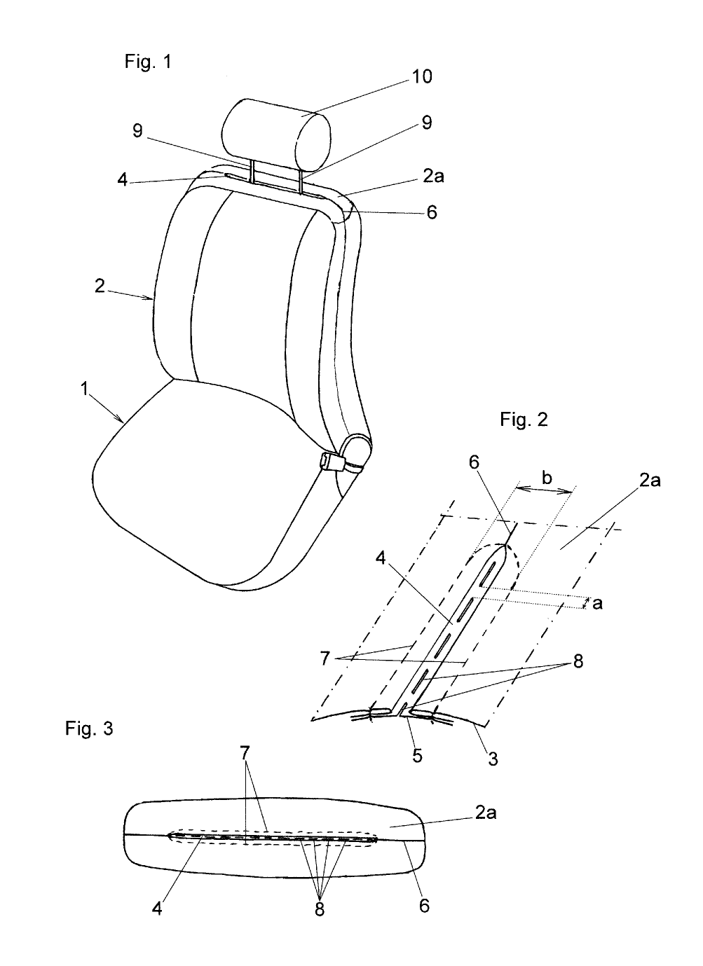

An exemplary embodiment of the invention is shown in FIGS. 1 to 3 in simplified and partially schematic form. The protective cover may have a cover part 1 covering the seat part of the vehicle seat and a cover part 2 covering the backrest of the vehicle seat. The cover parts 1 and 2 may be connected together or may be configured as separate parts. The cover part 2 covering the backrest may be configured in the manner of a bag. Elements for tensioning the cover parts 1, 2 which may be arranged, for example, below the seat part of the vehicle seat, are not shown in the figures and may be configured according to the prior art.

The cover part 2 has a portion 2a bearing against the upper narrow face of the backrest. In this portion 2a the cover fabric 3 is provided with a slot 4 extending longitudinally along the upper narrow face of the backrest. Below the slot 4 is located a strip 5 which extends beyond said slot on both longitudinal sides of the slot 4 and closes the slot 4 (apart from the incisions or openings provided in the strip 5 which are described below).

The slot 4 may, for example, interrupt a seam 6, a front part and a rear part of the cover part 2 being connected together thereby. For forming the slot 4 with the underlaid strip 5, the cover fabric 3 may be folded over and the strip 5 stitched with the folded-over cover fabric 3 along a seam 7. The cover fabric 3 could also be folded over twice and stitched.

Separate seams which, on the one hand, secure the edge of the slot and, on the other hand, connect the strip 5 to the cover fabric 3 could also be provided.

The connection of the strip 5 to the cover fabric 3 and/or the securing of the edge of the slot 4 could alternatively be implemented by one (respective) seam or additionally by an adhesively bonded connection.

In the exemplary embodiment, the strip 5 is formed of a layer (=film) of rubber. An embodiment formed of an elastically expandable textile material, however, is also conceivable and possible.

A plurality of incisions or openings 8 which are spaced apart from one another in the longitudinal direction of the strip are incorporated in the strip 5, said incisions or openings being located in the region of the slot 4, i.e. being accessible through the slot 4. The spacings a between adjacent incisions or openings 8 are less than 2 cm, preferably less than 1 cm, measured in the longitudinal direction of the strip 5.

In order to permit a sufficient displacement of the incisions or openings 8, in particular in the longitudinal direction of the strip 5, the spacing b between the connecting regions of the strip 5 with the cover fabric 3, said connecting regions being located on either side of the slot 4 (and in this exemplary embodiment being formed by portions of the seam 7) is at least 8 mm, preferably at least 1 cm, measured in the direction at right-angles to the longitudinal extent of the slot 4.

After the protective cover has been placed on the vehicle seat, with the headrest removed, the portion 2a of the cover part 2 comprising the slot 4 is located on the upper narrow face of the backrest of the vehicle seat. Now the anchoring rods 9 of the headrest 10 may be inserted through suitable incisions or openings 8 in the receivers provided therefor in the vehicle seat. If none of the incisions and/or none of the openings 8 are located directly above the respective receiver, the strip 5 in the region of an incision and/or an opening 8 which has the smallest spacing from the relevant receiver may be sufficiently expanded until the incision and/or opening is located directly above the receiver. The protective cover is suitable, therefore, for different types of vehicle seat in which the positions of the anchoring rods 9 differ, without incisions having to be retrospectively introduced by the user at the respective positions of the anchoring robs.

By the design according to the invention, the slot 4 may be reliably prevented from gaping.

It is also possible to pass through anchoring rods of different diameters.

In a modified embodiment, a separate slot 4 with an elastic strip 5 which has spaced-apart incisions or openings 8 may be provided for each of the anchoring rods 9.

In a similar manner, through-passages may be provided for other functional elements of a motor vehicle seat. For example, a slot with an underlaid elastic strip 5, which in the region of the slot has spaced-apart incisions or openings, may be provided on a lateral narrow face of the backrest in order to permit the through-passage of an adjusting lever through one of the incisions or openings.

The protective cover may also be provided for covering a rear seat bench of a motor vehicle. Here, in a similar manner as described in connection with the through-passage of the anchoring rods 9 of the headrest 10, a through-passage of anchoring parts for an ISO-fix child seat fastening may be permitted. For example, the through-passage of a belt buckle may also be permitted in this manner.

Depending on the manner of producing the strip 5, incisions or openings 8 may be incorporated therein after the production of the strip 5 or openings 8 may already be formed during the production of the strip 5. Thus when the strip 5 is formed by machine knitting, openings 8 may be formed during the production of the machine-knitted strip. When formed as a woven strip, incisions or openings may be incised retrospectively, for example by punching, and the edges bound or, when formed from a fusible material, sealed-in.

When the strip is formed from a continuous film material, incisions or openings are preferably incorporated after the production of the strip, for example by punching. Binding of the edges is generally not required.

The incisions which are incorporated in the strip 5 may, for example, be configured to be linear or cross-shaped.

When the strip 5 is formed from a knitted fabric it is conceivable and possible to achieve the elastic deformability of the strip simply by the knitted structure. Preferably, however, elastically expandable threads may also be provided.

In the exemplary embodiment, the strip 5 is configured to be continuously elastic. It is conceivable and possible that the strip has unexpandable or less expandable regions adjoining its longitudinal edges. Advantageously, the connections to the cover fabric 3 may be formed in these unexpandable or less expandable regions. In this case, the strip is only elastically expandable or more easily expandable and/or further elastically expandable in a central region of its width.

In a modified embodiment, it may be provided that a reinforcing strip connected to the cover fabric 3 is arranged between the cover fabric 3 and the strip 5, said reinforcing strip also having a slot in the region of the slot of the cover fabric. In this case, the slot in the reinforcing strip preferably has at least the expansion of the slot 4 in the cover fabric 3. The reinforcing strip may be connected to the cover fabric by being stitched on. Adhesive bonding is also conceivable and possible. If the reinforcing strip is stitched onto the cover fabric, a common seam may be provided for connecting the strip 5 and the reinforcing strip to the cover fabric or separate seams may be present.

### LEGEND TO THE REFERENCE NUMERALS

1 Cover part
2 Cover part
2a Portion
3 Cover fabric
4 Slot
5 Strip
6 Seam
7 Seam
8 Incision or opening
9 Anchoring rod
10 Headrest

1. A protective cover for a motor vehicle seat, the protective cover comprising:
a cover fabric having a slot,
a strip that underlays the slot and which is connected on either side of the slot to the cover fabric,
the strip is elastically expandable at least in a central region thereof, and the slot is located above the central region, and
the central region is provided with at least two incisions or openings that are spaced apart from one another in a longitudinal direction of the strip and which are accessible through the slot.

2. The protective cover according to claim 1, spacings between successive ones of the incisions or openings are less than 2 cm measured in the longitudinal direction of the strip.

3. The protective cover according to claim 2, further comprising connecting regions of the strip with the cover fabric being located on either side of the slot, and a spacing between connecting regions of the strip with the cover fabric, measured perpendicular to a longitudinal extent of the slot, is at least 8 mm.

4. The protective cover according to claim 1, wherein the slot is arranged in a portion of the protective cover which is provided for bearing against an upper narrow face of a backrest of the motor vehicle seat, and the slot forms a through-passage for at least one anchoring bar of a headrest.

5. The protective cover according to claim 1, wherein the strip, at least in a central region relative to a width thereof is comprises of a rubber-elastic material, said slot being located above said central region.

6. The protective cover according to claim 5, wherein the strip is formed from a continuous material layer.

7. The protective cover according to claim 1, wherein the strip is formed from a textile material.

8. The protective cover according to claim 1, wherein the strip is stitched onto the cover fabric, and a seam on either side of the slot has portions extending parallel to the slot.

9. The protective cover according to claim 1, further comprising a reinforcing strip connected to the cover fabric arranged between the cover fabric and the strip, said reinforcing strip also having a slot in a region of the slot of the cover fabric.

10. The protective cover according to claim 9, wherein the reinforcing strip is stitched onto the cover fabric.

11. The protective cover according to claim 1, wherein the strip, at least in a central region relative to a width thereof consists of a rubber-elastic material, said slot being located above said central region.

12. The protective cover according to claim 1, wherein cover fabric includes a plurality of the slots, and respective ones of the strips underlay the slots.
